(19) United States
(12) Patent Application Publication
(10) Pub. No.: US 2026/0071969 A1
(43) Pub. Date: Mar. 12, 2026

(54) Device and Method for Display Panel Fragment Detection, Electronic Apparatus, and Chip

(71) Applicant: Chipone Technology (Beijing ) Co., Ltd., Beijing (CN)

(72) Inventor: Chia Hao Hsu, Beijing (CN)

(73) Assignee: Chipone Technology (Beijing) Co., Ltd., Beijing (CN)

(21) Appl. No.: 19/388,155

(22) Filed: Nov. 13, 2025

Related U.S. Application Data
(63) Continuation of application No. PCT/CN2023/131306, filed on Nov. 13, 2023.

(30) Foreign Application Priority Data
Sep. 7, 2023 (CN) 202311154250.6

(51) Int. Cl. G01N 21/88; G01N 21/95

(52) U.S. Cl. CPC G01N 21/8806; G01N 21/95

(57) ABSTRACT

The present disclosure relates to a device and a method for display panel fragment detection, an electronic apparatus, and a chip. The device comprises at least one light source, at least one photosensitive element, and a computing unit, wherein the light source and the photosensitive element are arranged on opposite edges of a display panel; the at least one photosensitive element is configured to receive an optical signal emitted by the at least one light source and detect an intensity of at least one optical signal; and the computing unit is configured to compare the intensity of the at least one optical signal with a preset signal intensity threshold to determine a first optical signal having an intensity lower than the preset signal intensity threshold, and determine a fragment position based on an optical path corresponding to the first optical signal.

### CROSS-REFERENCE TO RELATED APPLICATIONS

The present application is a continuation of and claims priority under 35 U.S. C. § 120 to International Application. No. PCT/CN2023/131306, filed on Nov. 13, 2023, which claims priority to Chinese Patent Application No. 202311154250.6 filed on Sep. 7, 2023, entitled “Device and Method for Display Panel Fragment Detection, Electronic Apparatus, and Chip”. All the above referenced priority document is incorporated herein by reference in its entirety.

### TECHNICAL FIELD

The present disclosure relates to the technical field of detection, in particular to a device and a method for display panel fragment detection, an electronic apparatus and a chip, and a computer program product.

### BACKGROUND

The display panel (hereinafter referred to as “panel”) is an important component of electronic displays. It consists of multiple elements, such as an LCD backplane, a mask, and a brightness adjustment device, and comes in various sizes and functionalities. Panels are widely used in applications such as televisions, computers, mobile phones, vehicle-mounted displays, and outdoor display devices.

When a panel develops fragments, it not only affects the display performance, but also, if the fragments are not promptly detected to allow timely replacement or repair of the damaged panel, may lead to expansion of the fragmented area, severely affecting user experience.

### SUMMARY

In view of the above, the present disclosure proposes a display panel fragment detection solution.

According to one aspect of the present disclosure, there is provided a device for display panel fragment detection, comprising at least one light source, at least one photosensitive element, and a computing unit, wherein the light source and the photosensitive element are arranged on opposite edges of a display panel;

the at least one photosensitive element is configured to receive an optical signal emitted by the at least one light source and detect an intensity of at least one optical signal; and the computing unit is configured to compare the intensity of the at least one optical signal with a preset signal intensity threshold to determine a first optical signal having an intensity lower than the preset signal intensity threshold, and determine a fragment position based on an optical path corresponding to the first optical signal.

In one possible implementation, the computing unit comprises:
a fragment region determination unit configured to determine, based on a preset length, a fragment region with the optical path corresponding to the first optical signal as a central axis; and
a first fragment positioning unit configured to determine the fragment region as the fragment position.

In one possible implementation, determining the first optical signal comprises determining multiple first optical signals, and the computing unit comprises:
a second fragment positioning unit configured to determine an intersection point of optical paths corresponding to two of the multiple first optical signals as the fragment position.

In one possible implementation, the device comprises a plurality of light sources and a plurality of photosensitive elements, the plurality of light sources are activated one by one based on a preset activation sequence. After one light source is deactivated, a next light source and at least one photosensitive element are activated simultaneously. Each light source corresponds to a first coordinate, and each photosensitive element corresponds to a second coordinate. The device further comprises:
a coordinate acquisition unit configured to acquire the first coordinate of a light source corresponding to the first optical signal and the second coordinate of a corresponding photosensitive element; and
a first optical path determination unit configured to determine the optical path corresponding to the first optical signal based on the first coordinate and the second coordinate.

In one possible implementation, the at least one light source and the at least one photosensitive element are activated simultaneously. Each light source corresponds to a first identifier and a first coordinate, and each photosensitive element corresponds to a second identifier and a second coordinate. The device further comprises;
a first time length determination unit configured to determine a first time length from emission to reception of the first optical signal, wherein for a photosensitive element, time lengths from the emission to the reception of optical signals emitted by the at least one light source vary;
a first identifier acquisition unit configured to acquire a first identifier corresponding to a photosensitive element that receives the first optical signal;
a second identifier determination unit configured to determine a second identifier of a light source corresponding to the first optical signal based on the first identifier and the first time length; and
a second optical path determination unit configured to determine the optical path corresponding to the first optical signal based on the first coordinate corresponding to the first identifier and the second coordinate corresponding to the second identifier.

According to another aspect of the present disclosure, there is provided a chip which comprises any one device for display panel fragment detection as described above.

According to another aspect of the present disclosure, there is provided a method of display panel fragment detection, comprising: detecting an intensity of at least one optical signal that is received, the at least one optical signal being emitted by at least one light source and received by at least one photosensitive element, the light source and the photosensitive element being arranged on opposite sides of a screen; comparing the at least one optical signal with a preset signal intensity threshold to determine a first optical signal having an intensity lower than the preset signal intensity threshold; and determining a fragment position based on an optical path corresponding to the first optical signal.

In one possible implementation, determining the fragment position based on the optical path corresponding to the at least one first optical signal comprises: determining, based on a preset length, a fragment region with the optical path corresponding to the first optical signal as a central axis; and determining the fragment region as the fragment position.

In one possible implementation, determining the fragment position based on the optical path corresponding to the at least one first optical signal comprises: determining an intersection point of optical paths corresponding to two first optical signals as the fragment position.

In one possible implementation, the device comprises a plurality of light sources and a plurality of photosensitive elements, the plurality of light sources are activated one by one based on a preset activation sequence. After one light source is deactivated, a next light source and at least one photosensitive element are activated simultaneously. Each light source corresponds to a first coordinate, and each photosensitive element corresponds to a second coordinate. The method further comprises: acquiring the first coordinate of a light source corresponding to the first optical signal and the second coordinate of a corresponding photosensitive element; and determining the optical path corresponding to the first optical signal based on the first coordinate and the second coordinate.

In one possible implementation, the at least one light source and the at least one photosensitive element are activated simultaneously. Each light source corresponds to a first identifier and a first coordinate, and each photosensitive element corresponds to a second identifier and a second coordinate. The method further comprises: determining a first time length from emission to reception of the first optical signal, wherein for a photosensitive element, time lengths from the emission to the reception of optical signals emitted by the at least one light source vary; acquiring a first identifier corresponding to a photosensitive element that receives the first optical signal; determining a second identifier of a light source corresponding to the first optical signal based on the first identifier and the first time length; and determining the optical path corresponding to the first optical signal based on the first coordinate corresponding to the first identifier and the second coordinate corresponding to the second identifier.

According to another aspect of the present disclosure, there is provided an electronic apparatus, comprising: a processor; and a memory for storing processor executable instructions, wherein the processor is configured to implement the above methods upon executing the instructions stored in the memory.

According to another aspect of the present disclosure, there is provided a non-transitory computer readable storage medium having computer program instructions stored therein, wherein the computer program instructions, when executed by a processor, implement the method as described above.

According to another aspect of the present disclosure, there is provided a computer program product comprising computer readable code, or a non-transitory computer readable storage medium carrying the computer readable code, wherein when the computer readable code runs in a processor of an electronic apparatus, the processor of the electronic apparatus performs the method as described above.

The device according to the embodiment of the present disclosure comprises at least one light source, at least one photosensitive element, and a computing unit, wherein the light source and the photosensitive element are arranged on opposite edges of a display panel; the at least one photosensitive element is configured to receive an optical signal emitted by the at least one light source and detect an intensity of at least one optical signal; and the computing unit is configured to compare the at least one received optical signal with a preset signal intensity threshold to determine a first optical signal having an intensity lower than the preset signal intensity threshold, and determine a fragment position based on an optical path corresponding to the first optical signal. In this way, it is possible to detect whether there are fragments at the edge of the panel and/or within the edge of the panel, and determine the positions of the fragments. This allows for timely replacement or repair of the panel, reducing the probability of affecting image display. Moreover, the device according to the present disclosure only requires provision of the light source and the photosensitive element on opposite sides of the panel, which achieves not only space saving, i.e., freeing up room for other elements and reducing the overall volume of an apparatus containing the panel, but also cost saving.

Other features and aspects of the present disclosure will become apparent in light of the following detailed descriptions of the exemplary embodiments with reference to the drawings.

### BRIEF DESCRIPTION OF THE DRAWINGS

The drawings, which are incorporated in and constitute a part of the description, together with the description, illustrate exemplary embodiments, features, and aspects of the present disclosure and serve to explain the principle of the present disclosure.

FIG. 1 is a schematic structural diagram of a device for display panel fragment detection according to an embodiment of the present disclosure.

FIG. 2 is a schematic structural diagram of an alternating arrangement of light sources and photosensitive elements according to an embodiment of the present disclosure.

FIG. 3 is a schematic structural diagram of an arrangement where light sources and photosensitive elements are arranged on opposite sides of a panel, respectively, according to an embodiment of the present disclosure.

FIG. 4 is a schematic flow diagram of a method of display panel fragment detection according to an embodiment of the present disclosure.

FIG. 5 is a schematic structural diagram of an electronic apparatus for display panel fragment detection according to an embodiment of the present disclosure.

### DETAILED DESCRIPTION

Various exemplary embodiments, features and aspects of the present disclosure will be explained in detail below with reference to the drawings. In the drawings, the same reference signs denote elements with the same or similar functions. Although various aspects of the embodiments are shown in the drawings, unless otherwise specified, the drawings are not necessarily drawn to scale.

In the description of the present disclosure, it is appreciated that the orientations or positional relationships indicated by the terms “length”, “width”, “up”, “down”, “front”, “rear”, “left”, “right”, “vertical”, “horizontal”, “top”, “bottom”, “in”, “out”, and the like are based on the drawings, and these terms are only used for convenience and simplification of the description of the present disclosure, and are not intended to indicate or imply that the referred devices or elements must have a specific orientation or must be constructed and operated in a specific orientation, and therefore they shall not be interpreted as restricting the present disclosure.

The words “first” and “second” are only used for descriptive purposes, and cannot be interpreted as indicating or implying relative importance or implicitly indicating the number of the technical feature concerned. Therefore, if a feature is defined by “first” or “second”, it may explicitly indicate or implicitly indicate that there is one or more of this feature. In the description of the present disclosure, “a plurality of”means two or more, unless otherwise specified.

In the present disclosure, unless otherwise specified and defined, terms such as “mount”, “connect” and “fix” should be interpreted in a broad sense. For example, the connection can be a fixed connection, a detachable connection, or an integrated connection; the connection can be a mechanical connection or an electrical connection; the connection can be a direct connection or an indirect connection through a medium; and the connection can be an internal communication between two elements or an interaction between two elements. For those of ordinary skill in the art, the specific meanings of the above terms in the present disclosure can be understood according to specific situations.

The term “and/or” used herein is only for describing an association relationship between the associated objects, which means that there may be three relationships, for example, A and/or B may denote three situations: A exists alone, both A and B exist, and B exists alone. Furthermore, the expression “at least one” used herein implies any one of a plurality of elements or any combination of at least two of a plurality of elements. For example, including at least one of A, B and C can imply that any one element or more than one element selected from a group consisting of A, B and C is included.

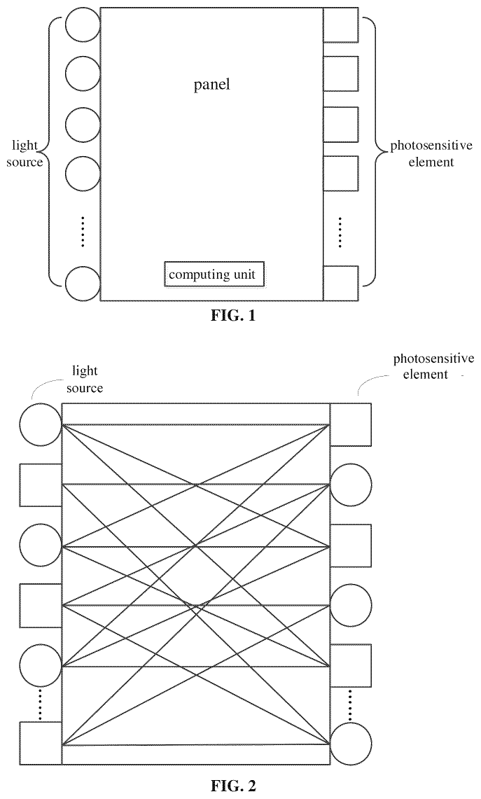

FIG. 1 is a schematic structural diagram of a device for display panel fragment detection according to an embodiment of the present disclosure.

As shown in FIG. 1, the device comprises at least one light source, at least one photosensitive element, and a computing unit, wherein the light source and the photosensitive element are arranged on opposite edges of a display panel; the at least one photosensitive element is configured to receive an optical signal emitted by the at least one light source and detect an intensity of the at least one optical signal; and the computing unit is configured to compare the intensity of the at least one optical signal with a preset signal intensity threshold to determine a first optical signal having an intensity lower than the preset signal intensity threshold, and determine a fragment position based on an optical path corresponding to the at least one first optical signal.

In FIG. 1, circular icons on one side of the panel may represent light sources in the device, while square icons on the other side of the panel may represent photosensitive elements in the device. The panel further comprises a computing unit. The computing unit may be disposed at any position within the panel or outside the panel, and the embodiments of the present disclosure do not limit the position of the computing unit. The photosensitive elements may be connected to the computing unit via wired or wireless means, transmitting at least the intensity of the optical signals detected by the photosensitive elements to the computing unit. For example, the computing unit of the present disclosure can be implemented with any known device with general computing functions, e.g., controller or processor, which might be programmable to perform the required functions.

According to an embodiment of the present disclosure, the light sources and the photosensitive elements may be arranged on the left side and the right side of the panel, respectively (as shown in FIG. 1). Alternatively, they may be arranged on the upper side and the lower side of the panel, respectively (not shown in FIG. 1). Moreover, the light source in the embodiments of the present disclosure may be a built-in light source of the panel or may be a light source other than a built-in light source of the panel, The light source may be a constant current light source, an alternating current light source, a pulse width modulation (PWM) light source, etc. The number of light sources and the number of photosensitive elements may be the same or different.

According to an embodiment of the present disclosure, the panel may be a single liquid crystal panel or a liquid crystal panel wall formed by arranging multiple liquid crystal panels.

The light emitted from the light source may be refracted through the panel to produce refracted light. According to an embodiment of the present disclosure, the optical signal may be an electrical signal converted from the refracted light. The device according to an embodiment of the present disclosure may further comprise a reflector (not shown in FIG. 1). The reflector may reflect the light emitted by the light source to one or more preset photosensitive elements. The optical signal may be an electrical signal converted from this reflected light.

According to an embodiment of the present disclosure, there may be multiple preset signal intensity thresholds. For an optical signal from one light source, each photosensitive element may correspond to a preset signal intensity threshold.

For example, the device may comprise two light sources, namely a light source A and a light source B, and may further comprise two photosensitive elements, namely a photosensitive element A and a photosensitive element B. In this case, both the photosensitive element A and the photosensitive element B are capable of receiving light emitted by the light source A and the light source B. The photosensitive element A may receive an optical signal AA emitted by the light source A and may determine the intensity of the optical signal AA. The computing unit may compare the optical signal AA with a first preset signal intensity threshold. The photosensitive element A may receive an optical signal AB emitted by the light source B and may determine the intensity of the optical signal AB. The computing unit may compare the optical signal AB with a second preset signal intensity threshold. The photosensitive element B may receive an optical signal BA emitted by the light source A and may determine the intensity of the optical signal BA. The computing unit may compare the optical signal BA with a third preset signal intensity threshold. The photosensitive element B may receive an optical signal BB emitted by the light source B and may determine the intensity of the optical signal BB. The computing unit may compare the optical signal BB with a fourth preset signal intensity threshold.

Therefore, when the intensity of an optical signal is lower than the corresponding preset signal intensity threshold, the optical signal is determined as the first optical signal. The fragment position may be a position on the optical path corresponding to the first optical signal. Alternatively, a preset range containing the optical path corresponding to the first optical signal may be determined as the fragment position.

The device according to the embodiment of the present disclosure comprises at least one light source, at least one photosensitive element, and a computing unit, wherein the light source and the photosensitive element are arranged on opposite edges of a display panel; the at least one photosensitive element is configured to receive an optical signal emitted by the at least one light source and detect an intensity of at least one optical signal; and the computing unit is configured to compare the at least one received optical signal with a preset signal intensity threshold to determine a first optical signal having an intensity lower than the preset signal intensity threshold, and determine a fragment position based on an optical path corresponding to the first optical signal. In this way, it is possible to detect whether there are fragments at the edge of the panel and/or within the edge of the panel, and determine the positions of the fragments. This allows for timely replacement or repair of the panel, reducing the probability of affecting image display. Moreover, the device according to the present disclosure only requires provision of the light source and the photosensitive element on opposite sides of the panel, which achieves not only space saving, i.e., freeing up room for other elements and reducing the overall volume of an apparatus containing the panel, but also cost saving.

In one possible implementation, the computing unit comprises: a fragment region determination unit configured to determine, based on a preset length, a fragment region with the optical path corresponding to the first optical signal as a central axis; and a first fragment positioning unit configured to determine the fragment region as the fragment position.

According to an embodiment of the present disclosure, the fragment position may be represented as a position corresponding to a region.

In one example, the fragment region may be rectangular. The computing unit may use the length of the optical path corresponding to the first optical signal as the length of the long side of the fragment region, and use a preset length as the length of the short side of the fragment region. The optical path corresponding to the first optical signal may be taken as the central axis, and the region enclosed by the two long sides and the two short sides is defined as the fragment region. The position of the fragment region is taken as the fragment position.

In another example, the fragment region may be elliptical. The computing unit may take the optical path corresponding to the first optical signal as the major axis, and determine the minor axis that is perpendicular to the major axis and passes through the midpoint of the major axis, wherein the length of the minor axis may be a preset length. The elliptical region defined by the major axis and the minor axis may be determined as the fragment region, and the position of the fragment region may be determined as the fragment position.

According to an embodiment of the present disclosure, the computing unit may determine the fragment region based on the preset length and the optical path corresponding to the first optical signal, and determine the fragment region as the fragment position. This approach may not only detect whether fragments exist in the panel but also determine the fragment region, thereby narrowing the investigation scope for locating the fragment coordinates and improving both the efficiency and accuracy of fragment coordinate determination.

In one possible implementation, determining the first optical signal comprises determining multiple first optical signals, and the computing unit comprises a second fragment positioning unit configured to determine an intersection point of optical paths corresponding to two of the multiple first optical signals as the fragment position.

The fragment position may be represented by point coordinates. According to an embodiment of the present disclosure, when there are two first optical signals and the optical paths respectively corresponding to these two first optical signals intersect, the computing unit may determine the coordinates of the intersection point of the optical paths respectively corresponding to the two first optical signals as the fragment position. Thus, the fragments may be directly located, improving the efficiency of fragment position determination.

In one possible implementation, the device comprises a plurality of light sources and a plurality of photosensitive elements, the plurality of light sources are activated one by one based on a preset activation sequence. After one light source is deactivated, a next light source and at least one photosensitive element are activated simultaneously. Each light source corresponds to a first coordinate, and each photosensitive element corresponds to a second coordinate. The device further comprises: a coordinate acquisition unit configured to acquire the first coordinate of a light source corresponding to the first optical signal, and the second coordinate of a corresponding photosensitive element; and a first optical path determination unit configured to determine the optical path corresponding to the first optical signal based on the first coordinate and the second coordinate.

Taking FIG. 1 as an example, the light sources may be activated one by one from top to bottom, or conversely from bottom to top. Alternatively, based on the probability of fragment occurrence, light sources corresponding to regions prone to fragments may be activated first, followed by those corresponding to regions with low fragment occurrence probability. By way of example, the topmost light source and the bottommost light source may be alternately activated first, and the remaining light sources are then activated one by one from top to bottom and from bottom to top in an alternating manner. For example, if there are five light sources on the left side of the panel, labeled as a light source a, a light source b, a light source c, a light source d, and a light source e from top to bottom, and assuming that the regions where the upper and lower edges of the panel are located are prone to fragments while the middle portion of the panel is less likely to have fragments, the preset activation sequence of the light sources may be: the light source a, the light source e, the light source b, the light source d, and the light source c. The light sources corresponding to fragment-prone regions emit enhanced optical signals in these regions, such that the intensity of the optical signals is sensitive to fragments, thereby improving the accuracy of fragment position determination. The above is merely an example, and the embodiments of the present disclosure do not limit the preset activation sequence of the light sources.

According to an embodiment of the present disclosure, the first coordinate corresponding to a light source and the second coordinate corresponding to a photosensitive element may be pre-stored. Since only one light source is activated at a time, an end of an optical path determined each time is the activated light source, and the other end is the photosensitive element. When a light source is activated, the target light source is determined; and when the first optical signal is determined, the target photosensitive element corresponding to the first optical signal may be determined. The coordinate acquisition unit may acquire the first coordinate of the target light source and the second coordinate of the target photosensitive element. In other words, the first coordinate of the light source corresponding to the first optical signal and the second coordinate of the corresponding photosensitive element are acquired. For a first optical signal, a straight line may be constructed using the first coordinate and the second coordinate corresponding to the first optical signal. This straight line is used to represent the optical path corresponding to the first optical signal. Thus, the optical path corresponding to the first optical signal may be accurately located on the panel, thereby enhancing the accuracy of determining the fragment position.

In one possible implementation, the at least one light source and the at least one photosensitive element are activated simultaneously. Each light source corresponds to a first identifier and a first coordinate, and each photosensitive element corresponds to a second identifier and a second coordinate. The device further comprises: a first time length determination unit configured to determine a first time length from emission to reception of the first optical signal, wherein for a photosensitive element, time lengths from the emission to the reception of optical signals emitted by different light sources vary; a first identifier acquisition unit configured to acquire a first identifier corresponding to a photosensitive element that receives the first optical signal; a second identifier determination unit configured to determine a second identifier of a light source corresponding to the first optical signal based on the first identifier and the first time length; and a second optical path determination unit configured to determine the optical path corresponding to the first optical signal based on the first coordinate corresponding to the first identifier and the second coordinate corresponding to the second identifier.

According to an embodiment of the present disclosure, since the distances from a photosensitive element to different light sources are different, when at least one light source and at least one photosensitive element are activated simultaneously, the time lengths for a photosensitive element to receive the optical signals emitted by the at least one light source vary. However, the time length for a photosensitive element to receive an optical signal from the same light source may be fixed. The at least one time length corresponding to the same photosensitive element may be pre-stored, with one time length corresponding to one light source.

The first time length determination unit may measure the time length from the emission of an optical signal from any light source to the arrival of the optical signal at any photosensitive element. When the light source is an alternating current light source, the first time length determination unit may count the number of phases experienced by an optical signal emitted from any light source to any photosensitive element, and then take the product of the number of phases and the unit time corresponding to one phase as the time length from the emission to the reception of the optical signal. When the light source is a PWM light source, the first time length determination unit may count the number of pulses experienced by an optical signal emitted from any light source to any photosensitive element, and then take the product of the number of pulses and the unit time corresponding to one pulse as the time length from the emission to the reception of the optical signal. Therefore, an optical signal received by a photosensitive element corresponds to a time length. For ease of subsequent description, the time length corresponding to the first optical signal is defined as the first time length.

The optical signal is emitted from the light source and reaches the photosensitive element. Therefore, each optical signal may correspond to a first identifier and a second identifier. For a photosensitive element, upon receiving an optical signal, a first identifier corresponding to the received optical signal may be determined.

For a photosensitive element, the first identifier and the first time length corresponding to the first optical signal may be acquired.

In one example, the first time length may be compared with at least one pre-stored time length for the photosensitive element. A second time length with the numerical value of the pre-stored time length to which the value of the first time length is the closest is selected, the light source corresponding to the second time length is determined, and the second identifier corresponding to the light source is then determined.

In another example, the first time length may be compared with at least one pre-stored time length for the photosensitive element. A third time length with an error falling within a threshold range is selected, the light source corresponding to the third time length is determined, and the second identifier corresponding to the light source is then determined.

Thus, for a photosensitive element, the second identifier corresponding to the first optical signal may be determined.

According to an embodiment of the present disclosure, a second identifier and a first coordinate may be stored for a light source, and a first identifier and a second coordinate may be stored for a photosensitive element. A straight line may be constructed using the first coordinate and the second coordinate corresponding to the first optical signal, and the straight line is used to represent the optical path corresponding to the first optical signal. Thus, the optical path corresponding to the first optical signal may be accurately located on the panel, thereby enhancing the accuracy of determining the fragment position. Since at least one light source and at least one photosensitive element are activated simultaneously, the detection efficiency for fragments in the entire panel can be improved.

In one possible implementation, the at least one light source and the at least one photosensitive element are alternately arranged on opposite edges of the panel.

FIG. 2 is a schematic structural diagram of the alternating arrangement of light sources and photosensitive elements according to an embodiment of the present disclosure. As shown in FIG. 2, circular icons may represent light sources in the device, while square icons may represent photosensitive elements in the device. The connecting line between a light source and a photosensitive element defines an optical path. When at least one light source is activated one by one according to a preset activation sequence, the optical signal emitted by one light source covers a larger area, and fragments may be detected from both sides, improving the efficiency of detecting the presence of fragments and the efficiency of determining the fragment position.

In one possible implementation, the at least one light source is disposed on one side of the display panel, and the at least one photosensitive element is disposed on another side of the display panel.

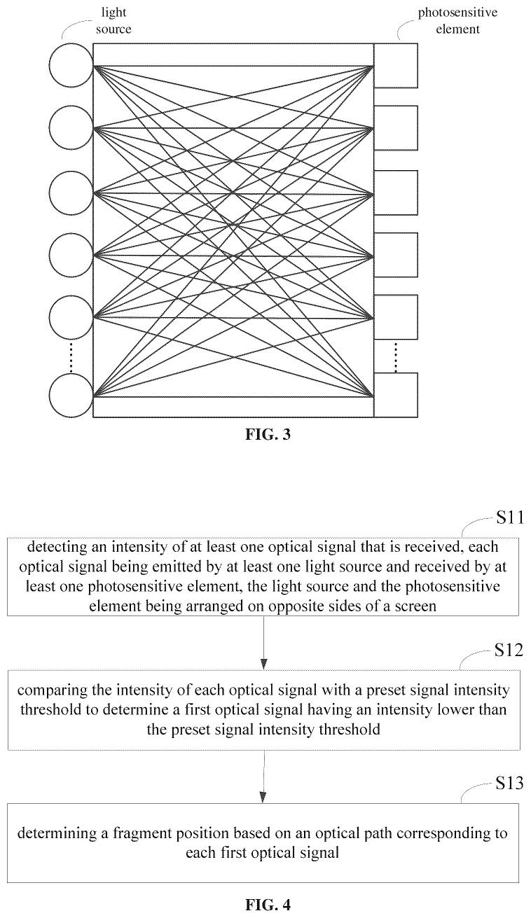

FIG. 3 is a schematic structural diagram of an arrangement where light sources and photosensitive elements are respectively arranged on the two sides of a panel, according to an embodiment of the present disclosure. As shown in FIG. 3, circular icons may represent the light sources in the device, and square icons may represent the photosensitive elements in the device. The connecting line between a light source and a photosensitive element defines an optical path. According to an embodiment of the present disclosure, one light source corresponds to a greater number of photosensitive elements. When the light sources and the photosensitive elements are activated simultaneously, the optical paths densely cover the panel, which may improve the accuracy of detecting the presence of fragments and the accuracy of determining the fragment position.

FIG. 4 is a schematic flow diagram of a method of display panel fragment detection according to an embodiment of the present disclosure. As shown in FIG. 4, the method comprises:
S11: detecting an intensity of at least one optical signal that is received, wherein the at least one optical signal is emitted by at least one light source and received by at least one photosensitive element, and the light source and the photosensitive element are arranged on opposite sides of a screen, respectively;
S12: comparing the at least one optical signal with a preset signal intensity threshold to determine a first optical signal having an intensity lower than the preset signal intensity threshold; and
S13: determining a fragment position based on an optical path corresponding to the first optical signal.

By way of example, the electronic apparatus in this embodiment includes, but is not limited to, a desktop computer, a television, a mobile device with a large-sized screen (such as a mobile phone and a tablet computer), and other conventional electronic apparatuses that require multi-chip cascade connections for driving.

By way of example, the electronic apparatus may also be user equipment (UE), a mobile device, a user terminal, a terminal, a handheld device, a computing device, a vehicle-mounted device, or similar devices. By way of example, examples of the terminal include displays, smartphones or portable devices, mobile phones, tablet computers, laptops, handheld computers, mobile Internet devices (MIDs), wearable devices, virtual reality (VR) devices, augmented reality (AR) devices, wireless terminals in industrial control, wireless terminals in self-driving, wireless terminals in remote medical surgeries, wireless terminals in smart grids, wireless terminals in transportation safety, wireless terminals in smart cities, wireless terminals in smart homes, and wireless terminals in Internet of Vehicles. For example, the server may be a local server or a cloud server.

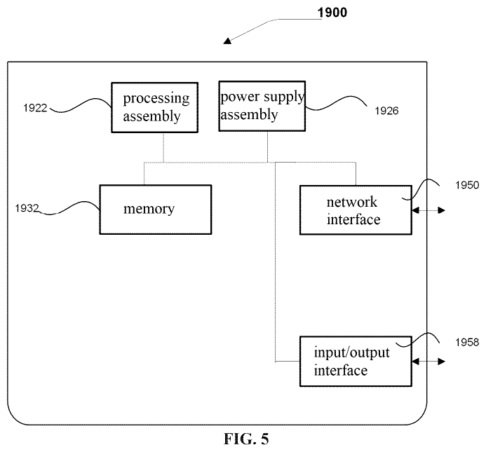

FIG. 5 is a schematic structural diagram of an electronic apparatus for display panel fragment detection according to an embodiment of the present disclosure. For example, the electronic apparatus 1900 may be provided as a server or a terminal device. Referring to FIG. 5, the electronic apparatus 1900 comprises a processing assembly 1922, which further comprises one or more processors, and memory resources represented by a memory 1932 for storing instructions executable by the processing assembly 1922, such as application programs. The application programs stored in the memory 1932 may include one or more modules, each corresponding to a set of instructions. In addition, the processing assembly 1922 is configured to execute the instructions to carry out the above methods.

The electronic apparatus 1900 may further comprise a power supply assembly 1926 configured to perform power management of the electronic apparatus 1900, a wired or wireless network interface 1950 configured to connect the electronic apparatus 1900 to a network, and an input/output (I/O) interface 1958. The electronic apparatus 1900 may operate based on an operating system stored in the memory 1932, such as Windows Server™, Mac OS X™, Unix™ Linux™, and FreeBSD™.

In an exemplary embodiment, there is further provided a non-transitory computer readable storage medium, such as the memory 1932 that includes computer program instructions. The computer program instructions may be executed by the processing assembly 1922 of the electronic apparatus 1900 to implement the above methods. The computer storage medium may be a transitory storage medium or a non-transitory storage medium.

The above descriptions are merely exemplary embodiments of the present disclosure and are not intended to limit the protection scope of the present disclosure. The protection scope of the present disclosure is defined by the appended claims.

The word “exemplary” used here means “serving as an example, embodiment or illustration”. Any embodiment described here as “exemplary” is not necessarily to be interpreted as superior to or better than other embodiments.

It is appreciated that the words “include”, “comprise” or any other variant thereof, as used herein, are intended to encompass non-exclusive inclusion, such that a process, a method, an article or an apparatus comprising a set of elements includes not only those elements, but also other elements that are not expressly listed, or elements that are inherent to such process, method, article or apparatus, Without further limitation, the fact that an element is defined by the expression “include/comprise a/one. ” does not exclude the existence of other identical elements in the process, method, article or apparatus including the above element.

The flowcharts and block diagrams in the drawings illustrate the architecture, function, and operation that may be implemented by the system, method and computer program product according to the various embodiments of the present disclosure. In this regard, each block in the flowchart or block diagram may represent a module, a program segment, or a portion of code, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions.

Although the embodiments of the present disclosure have been described above, it will be appreciated that the above descriptions are merely exemplary, but not exhaustive; and that the disclosed embodiments are not limiting. A number of variations and modifications may be obvious to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A device for display panel fragment detection, comprising at least one light source, at least one photosensitive element, and a computing unit, wherein
the light source and the photosensitive element are arranged on opposite edges of a display panel;
the at least one photosensitive element is configured to receive an optical signal emitted by the at least one light source and detect an intensity of at least one optical signal; and
the computing unit is configured to compare the intensity of the at least one optical signal with a preset signal intensity threshold to determine a first optical signal having an intensity lower than the preset signal intensity threshold, and determine a fragment position based on an optical path corresponding to the first optical signal.

2. The device according to claim 1, wherein the computing unit comprises:
a fragment region determination unit configured to determine, based on a preset length, a fragment region with the optical path corresponding to the first optical signal as a central axis; and
a first fragment positioning unit configured to determine the fragment region as the fragment position.

3. The device according to claim 1, wherein determining the first optical signal comprises determining multiple first optical signals, and the computing unit comprises:
a second fragment positioning unit configured to determine an intersection point of optical paths corresponding to two of the multiple first optical signals as the fragment position.

4. The device according to claim 1, wherein the device comprises a plurality of light sources and a plurality of photosensitive elements, the plurality of light sources are activated one by one based on a preset activation sequence; after one light source is deactivated, a next light source and at least one photosensitive element are activated simultaneously; each light source corresponds to a first coordinate, and each photosensitive element corresponds to a second coordinate, wherein the device further comprises:
a coordinate acquisition unit configured to acquire the first coordinate of a light source corresponding to the first optical signal and the second coordinate of a corresponding photosensitive element; and
a first optical path determination unit configured to determine the optical path corresponding to the first optical signal based on the first coordinate and the second coordinate.

5. The device according to claim 1, wherein the at least one light source and the at least one photosensitive element are activated simultaneously; each photosensitive element corresponds to a first identifier and a first coordinate, and each light source corresponds to a second identifier and a second coordinate, wherein the device further comprises:
a first time length determination unit configured to determine a first time length from emission to reception of the first optical signal, wherein for a photosensitive element, time lengths from the emission to the reception of optical signals emitted by the at least one light source vary;
a first identifier acquisition unit configured to acquire the first identifier corresponding to a photosensitive element that receives the first optical signal;
a second identifier determination unit configured to determine the second identifier of a light source corresponding to the first optical signal based on the first identifier and the first time length; and
a second optical path determination unit configured to determine the optical path corresponding to the first optical signal based on the first coordinate corresponding to the first identifier and the second coordinate corresponding to the second identifier.

6. The device according to claim 1, wherein the at least one light source is disposed on one side of the display panel, and the at least one photosensitive element is disposed on another side of the display panel.

7. A method of display panel fragment detection, comprising:
detecting an intensity of at least one optical signal that is received, the at least one optical signal being emitted by at least one light source and received by at least one photosensitive element, the light source and the photosensitive element being arranged on opposite sides of a screen;
comparing the intensity of the at least one optical signal with a preset signal intensity threshold to determine a first optical signal having an intensity lower than the preset signal intensity threshold; and
determining a fragment position based on an optical path corresponding to the first optical signal.

8. A computer program product comprising computer readable code, or a non-transitory computer readable storage medium carrying the computer readable code, wherein when the computer readable code runs in a processor of an electronic apparatus, the processor of the electronic apparatus implements a method of display panel fragment detection, the method comprising:
detecting an intensity of at least one optical signal that is received, the at least one optical signal being emitted by at least one light source and received by at least one photosensitive element, the light source and the photosensitive element being arranged on opposite sides of a screen;
comparing the intensity of the at least one optical signal with a preset signal intensity threshold to determine a first optical signal having an intensity lower than the preset signal intensity threshold; and
determining a fragment position based on an optical path corresponding to the first optical signal.
